(19) United States
(12) Patent Application Publication
(10) Pub. No.: US 2003/0114192 A1
(43) Pub. Date: Jun. 19, 2003

(54) Method for accessing extended capabilities in mobile communication device using a subscriber identity module

(76) Inventors: Charles D. Estes, Fort Lauderdale, FL (US); Josue Pena, Miami, FL (US); Robert H. Pichette, Plantation, FL (US)

Correspondence Address: MOTOROLA, INC, INTELLECTUAL PROPERTY SECTION, LAW DEPT, 8000 WEST SUNRISE BLVD, FT LAUDERDAL, FL, 33322, US

(21) Appl. No.: 10/022,588

(22) Filed: Dec. 17, 2001

(51) Int. Cl. H04M 1/00

(52) U.S. Cl. 455/558; 455/552; 455/411

(57) ABSTRACT

A mobile communication device (102) capable of performing non-standard communication modes, such as dispatch calling uses a subscriber identity module (SIM) (104). In order to allow the use of the non-standard, or extended features, the SIM has information for allowing use of the extended features stored therein (112). In order to determine if the SIM in the mobile communication device allows extended feature, the SIM must be checked upon initialization (202) of the mobile communication device. The mobile communication device has, stored in a non-volatile memory, a directory name or address of a feature directory in the SIM (111), and a copy of a feature signature file (111). The mobile communication device first checks to see if the directory is present (206) having the name stored in the mobile communication device, or at the address provided in the mobile communication device. If a directory exits, the mobile communication device looks for the feature signature file (210) and compares it to the copy stored in the mobile communication device (212). If the feature signature file matches, the extended features are enabled (214), and usable by the user of the mobile communication device.

### TECHNICAL FIELD

This invention relates in general to mobile communication devices and their operation, and in particular to mobile communication devices which use subscriber identity modules to enable extended features.

### BACKGROUND OF THE INVENTION

The use of subscriber identity modules (SIM) with mobile communication devices is common in mobile communication devices used in communication systems designed according to the Global Specification for Mobile (GSM) communications standard. A SIM is used to store information such as phone numbers and names of parties the user/owner of the SIM may wish to call. For the most part the user enters the information into the SIM with the aid of the user interface of the mobile communication device. The SIM can be removed from the phone and put into another phone, allowing the user to use the new phone without having to re-enter all of the phone numbers and names.

The data format of a SIM is dictated, in part, by a standards body. Certain portions of the memory space in a SIM are allocated for certain types of data. When inserted into a mobile communication device that recognizes the standard SIM format, the mobile communication device can easily and correctly access the right information for the activity in which the mobile communication device is engaged. For example, phone numbers are stored in a predetermined and standardized format, beginning at a predetermined memory address, and ending at a predetermined memory address. However, a SIM can have more memory space than is needed to conform to the standardized SIM format. This additional memory space may be used by manufactures for specific functions and features of their mobile communication devices, at least until that memory space also becomes described by a standard.

The fact that the additional memory space can, and is being used to provided extended functionality beyond standard operation has the potential to cause problems. If a user of a standard mobile communication device uses their SIM in another phone having extended features, the mobile communication device should still function at least as a standard mobile communication device. At the same time, features for which the user has not paid for should not be enabled. Therefore a need exists for a means by which standard and non-standard SIMs can be detected, and the appropriate features enabled or disabled.

### BRIEF DESCRIPTION OF THE DRAWINGS

FIG. 1 shows block diagram of mobile communication device and an associated SIM for use with the mobile communication device, in accordance with the invention; and

FIG. 2 shows a flow chart diagram of a method of accessing extended capabilities in mobile communication device using a SIM.

### DETAILED DESCRIPTION OF A PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

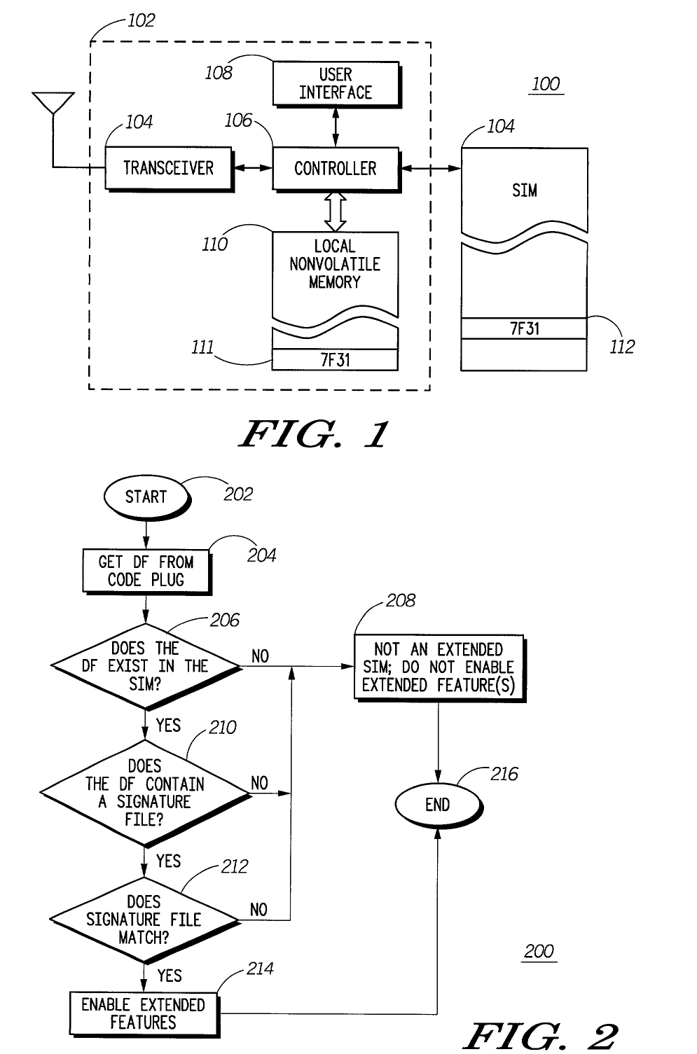

Referring to FIG. 1, there is shown a block diagram 100 of mobile communication device 102 and an associated subscriber identity module (SIM) 104 for use with the mobile communication device, in accordance with the invention. The mobile communication device comprises a transceiver 105 for receiving and transmitting audio signals at radio frequencies. The transceiver is controlled by a controller 106, as is known in the art. The controller also functions in conjunction with other hardware such as displays and keypads to provide a user interface 108. Through the user interface the mobile communication device can receive commands from the user and display information to the user. The controller operates according to program instructions stored in a local non-volatile memory 110. The memory also stores code sections for implementing any extended features the manufacturer wishes to have the mobile communication device perform. One example of an extended feature is dispatch calling. By dispatch calling it is meant simplex or half-duplex calling between two or more mobile communication devices. Dispatch calling typically is performed by the user selecting a target identifier, then pushing a “push to talk” (PTT) button to initiate the call. In a cellular mobile communication device, the call is facilitated by a fixed equipment network that sets up and routes signals from the serving cell of the originating caller to the service cell of the target caller, as is known in the art. The memory is also provided with a directory address and feature signature file 111. The directory address can be a logical address, or a directory name of a directory in the SIM and corresponds to an extended feature directory 112 if the SIM is the right type, i.e. an extended SIM. The SIM may be a standard or a non-standard SIM. A standard SIM contains only information for facilitating standard phone operation. A non-standard SIM facilitates extended or additional features or non-standard operation of the mobile communication device. If the SIM is a non-standard SIM designed to facilitate the specific non-standard features of the mobile communication device, the information will be stored in a specific feature directory 112. If the feature directory is present in the SIM, and if it contains the desired information for facilitating extended features on the particular mobile communication device, the feature directory will contain a feature signature, such as a particular character string. If the feature signature is present, the mobile communication device will enable use of the extended feature(s).

Referring now to FIG. 2, there is shown a flow chart diagram 200 diagram of a method of accessing extended capabilities in mobile communication device using a SIM. At the start 202, typically the mobile communication device is initialized, as occurs, for example, when the mobile communication device is first power up or turned on. As part of the initialization process, the mobile communication device checks the SIM. Checking the SIM first starts by the mobile communication device fetching the address or name of the feature directory (204). In the preferred embodiment, the feature directory address is stored in a designated location the codeplug of the mobile communication device. The codeplug is a section of non-volatile memory for storing parameters and data, as is known in the art. The device then searches the SIM (206) for a directory at the feature directory address, or having the feature directory name. If no directory is found at the address, or having the name of the feature directory, then the SIM is not an extended SIM, and only standard features will be enabled (208). If a directory exits at the address, or having the same name, then the mobile communication device searches the directory for a feature signature (210). The feature signature is a file which is compared to a copy of the file stored in the mobile communication device (212). The feature signature may be cryptographically encoded using asymmetric cryptography techniques to prevent unauthorized duplication. If the file found in the SIM matches the feature signature file stored in the mobile communication device, the mobile communication device commences enabling the extended features (214). Upon ending the process (216), the mobile communication device will continue initialization, including initializing executable code for implementing the extended features.

It is contemplated that the invention may be used for several purposes. For example, since there are many wireless communication service providers in business, many of these service providers, or carriers as they are alternatively known, desire to have the mobile communication device show a graphical carrier branding logo on a display of the device, such as in the user interface 108. This distinguishes the carrier from other carriers. The logo is stored in the SIM as an enhanced feature to be activated, and when the SIM is placed in another mobile communication device, the same carrier logo can be displayed to inform the user which carrier is providing service.

The invention can also be used to customize the mobile communication device for a certain ergonomic performance. This is beneficial because when the user switches to another mobile communication device, the enhanced features can set up the ergonomics of the new mobile communication device to be familiar to the user. Therefore, storing a preferred ergonomic set as an enhanced feature allows the user to be able to use different mobile communication devices with the SIM, while maintaining a familiar user interface. The ergonomics include aspects such as key mapping, message display, programming menus, and so on. By key mapping it is meant the operation associated with the physical buttons or keys provided on the mobile communication device. By use of an enhanced ergonomic feature set, these can de defined based on the information in the enhanced ergonomic feature set. Thus, enabling the extended feature for an ergonomic feature set defines the ergonomic operation of the mobile communication device.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for accessing extended capabilities in mobile communication device using a subscriber identity module (SIM), comprising:
providing in the mobile communication device at least one code section for implementing an extended feature;
providing in the mobile communication device a directory address of the SIM for an extended feature directory;
searching the SIM for a directory at the directory address;
searching the directory for a feature signature; and
enabling the extended feature if the feature signature is present in the directory.

2. The method of claim 1, wherein providing the directory address of the SIM, comprises providing the directory address of the SIM in a non-volatile, programmable memory of the mobile communication device.

3. The method of claim 1, wherein searching the directory for the feature signature comprises searching the directory for a feature signature file.

4. The method of claim 1, wherein searching the directory for the feature signature comprises searching the directory for an encrypted feature signature.

5. The method of claim 1, wherein if no directory is found at the directory address, or if no feature signature is found in the directory at the directory address, the method further comprising disabling the extended feature.

6. The method of claim 1, wherein searching the SIM for a directory at the directory address is done upon initializing the mobile communication device.

7. The method of claim 1, wherein enabling the extended feature comprises enabling a dispatch calling feature.

8. The method of claim 1, wherein enabling the extended feature comprises enabling a graphical carrier branding logo to be displayed on a display of the mobile communication device, wherein the graphical carrier branded logo is stored in the SIM.

9. The method of claim 1, wherein enabling the extended feature comprises enabling an ergonomic feature set to define the ergonomic operation of the mobile communication device.
